(19) United States
(12) Patent Application Publication
(10) Pub. No.: US 2016/0042700 A1
(43) Pub. Date: Feb. 11, 2016

(54) DISPLAY SHUTTER ASSEMBLIES INCLUDING FLUID-DYNAMIC SURFACE FEATURES

(71) Applicant: Pixtronix, Inc., San Diego, CA (US)

(72) Inventors: Joyce Wu, Somerville, MA (US); Mark Andersson, Northborough, MA (US); Tyler Dunn, North Reading, MA (US); Andrew William Sparks, Cambridge, MA (US)

(21) Appl. No.: 14/452,188

(22) Filed: Aug. 5, 2014

(51) Int. Cl. G09G 3/34; B32B 3/30; B32B 33/00; B32B 7/04

(52) U.S. Cl. CPC G09G 3/3433; B32B 7/045; B32B 3/30; B32B 33/00; B32B 2457/20

(57) ABSTRACT

This disclosure provides systems, methods and apparatus for a shutter-based light modulator. The shutter includes at least three depressions extending outward from the surface of the shutter. Any two adjacent depressions of the at least three depressions define a gap therebetween to reduce damping forces caused by fluids in which the shutter is immersed. In some implementations, the at least three depressions can be aligned into more than one row, each row including more than two of the at least three depressions, along the surface of the shutter. In some implementations, to improve structural stability of the shutter, depressions in one row are staggered with respect to depressions in another row.

### TECHNICAL FIELD

This disclosure relates to the field of displays, and in particular, to electromechanical systems (EMS) display elements.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including a substrate, an anchor disposed on the substrate; and a planar body supported over the substrate by the anchor, where the planar body includes, at least three depressions extending out of the plane of the planar body; where any two adjacent depressions of the at least three depressions define a gap therebetween, and where the at least three depressions are aligned along a surface of the planar body.

In some implementations, the at least three depressions extend out of the plane of the planar body and protrude towards the substrate. In some implementations, the at least three depressions are aligned in at least two rows, each row including more than two of the at least three depressions, along the surface of the planar body. In some implementations, gaps defined by any two adjacent depressions in one of the at least two rows align with a depression in another of the at least two rows in a direction of motion of the planar body.

In some implementations, the at least three depressions are aligned in at least two rows along the surface of the planar body such that any line, coplanar with the planar body, along a direction of motion of the planar body and intersecting an opening in the planar body passes through at least one of the at least three depressions. In some implementations, the at least three depressions are aligned in at least two rows along the surface of the planar body such that any line, coplanar with the planar body, passing through a gap defined by any two of the at least three depressions in one row intersects another of the at least three depressions in another row.

In some implementations, the at least three depressions include a leading edge that forms an angle with respect to a direction of motion of the planar body. In some implementations, any line, coplanar with the planar body, along a direction of motion of the planar body and intersecting an opening in the planar body passes thorough at least one of the at least three depressions. In some implementations, the lengths of the at least three depressions are less than or equal to about 25 microns. In some implementations, the at least three depressions are elliptical shaped.

In some implementations, the apparatus further includes a display, a processor that is capable of communicating with the display, the processor being capable of processing image data, and a memory device capable of communicating with the processor. In some implementations, the apparatus further includes a driver circuit capable of sending at least one signal to the display, and a controller capable of sending at least a portion of the image data to the driver circuit. In some implementations, the apparatus further includes an image source module capable of sending the image data to the processor, where the image source module includes at least one of a receiver, transceiver, and transmitter. In some implementations, the apparatus further includes an input device capable of receiving input data and communicating the input data to the processor.

Another innovative aspect of the subject matter described in this disclosure can be implemented in a method of forming a display apparatus. The method includes providing a substrate, forming a mold over the substrate, the mold having sidewalls substantially normal to the substrate, a top surface and a bottom surface substantially parallel to the substrate, and at least three projections, depositing a shutter material over the mold including over the at least three projections, and patterning the shutter material to form a shutter having an opening and at least three depressions aligned along a surface of the shutter, any two adjacent depressions of the at least three depressions defining a gap therebetween.

In some implementations, forming the mold over the substrate having at least three projections in the mold includes forming cavities within the top surface of the mold extending towards the substrate. In some implementations, forming the mold over the substrate having at least three projections in the mold includes forming posts in the mold extending away from the bottom surface of the mold.

In some implementations, patterning the shutter material includes patterning the shutter material to form the at least three depressions aligned in at least two rows, each row including more than two of the at least three depressions, along the surface of the shutter. In some implementations, patterning the shutter material to form the at least three depressions aligned in at least two rows along the surface of the shutter includes patterning the shutter material such that gaps defined by any two adjacent depressions in one of the at least two rows align with a depression in another of the at least two rows in a direction of motion of the shutter.

In some implementations, patterning the shutter material to form the at least three depressions aligned in at least two rows along the surface of the shutter includes patterning the shutter material such that any line, coplanar with the shutter, along a direction of motion of the shutter and intersecting the opening, passes through at least one of the at least three depressions. In some implementations, patterning the shutter material to form the at least three depressions aligned in at least two rows along the surface of the shutter includes patterning the shutter material such that any line, coplanar with the planar body, passing through a gap defined by any two of the at least three depressions in one row intersects another of the at least three depressions in another row.

In some implementations, patterning the shutter material to form a shutter having an opening and at least three depressions aligned along a surface of the shutter, any two adjacent depressions of the at least three depressions defining a gap therebetween, includes patterning the shutter material such that the at least three depressions include a leading edge forming an angle with respect to a direction of motion of the shutter. In some implementations, patterning the shutter material to form a shutter having an opening and at least three depressions aligned along a surface of the shutter, any two adjacent depressions of the at least three depressions defining a gap therebetween includes patterning the shutter material such that the lengths of the at least three depressions is less than or equal to about 25 microns. In some implementations, forming the mold over the substrate having at least three projections in the mold includes forming elliptical shaped at least three projections in the mold.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a top view of an example shutter assembly including a shutter having ribs.

FIG. 4 shows a cross-sectional view of the shutter of the example shutter assembly shown in FIG. 3.

FIGS. 5A-5C show various views of an example shutter assembly including a shutter having broken ribs.

FIGS. 6A-6C show various views of an example shutter having broken ribs.

FIGS. 7A and 7B show two views of an example shutter having angled ribs.

FIGS. 8A and 8B show two views of another example shutter having angled ribs.

FIG. 9 shows a top view of an example shutter having non-overlapping ribs.

FIG. 10 shows a top view of an example shutter having elliptical-shaped ribs.

FIG. 11 shows a flow diagram of an example process for forming a shutter assembly.

FIGS. 12A-12C show example stages of manufacturing a shutter assembly using the process shown in FIG. 11.

FIGS. 13A and 13B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, display devices can utilize shutter based light modulators for displaying images. The shutter based light modulators may be immersed in a fluid during operation. In some implementations, the shutters of the shutter based modulators can include ribs or depressions extending outward from the surface of the shutter to increase the rigidity of the shutter. However, driving a ribbed shutter through the fluid may need additional force due to the damping exhibited by the fluid. In some implementations, such damping can be reduced by forming one or more ribs or depressions separated by gaps. For example, in some implementations, at least three ribs or depressions separated by respective gaps can be formed to reduce damping. During the operation of the shutter, a damping of the motion of the shutter caused by the fluid can be reduced by the presence of the gaps between the depressions. In some implementations, the at least three depressions can be aligned in one or more rows along the surface of the shutter. In some implementations, the depressions can be tilted or angled in relation to an edge of the shutter.

Particular implementations of the subject matter described in this disclosure can be implemented to realize one or more of the following potential advantages. Including gaps in ribs or depressions formed within a surface of a shutter not only provide structural stability to the shutter, but also reduce the actuation voltage needed to operate the shutter or improve the speed of operation of the shutter. The gaps reduce the damping effect on the shutter due to a fluid in which the shutter is immersed. A reduction in the damping effect, in turn, allows a reduction in the actuation voltages needed to actuate the shutters, which reduces the overdrive necessary to achieve a desired switch time. In some implementations, portions of adjacent ribs can overlap along a line parallel to the direction of motion of the shutter, reducing risk of bending, and improving the structural stability, of the shutter. Additionally, the introduction of gaps in the ribs reduces the overall area of the ribs, which can improve the yield of displays by minimizing stiction forces between the backplane and shutter.

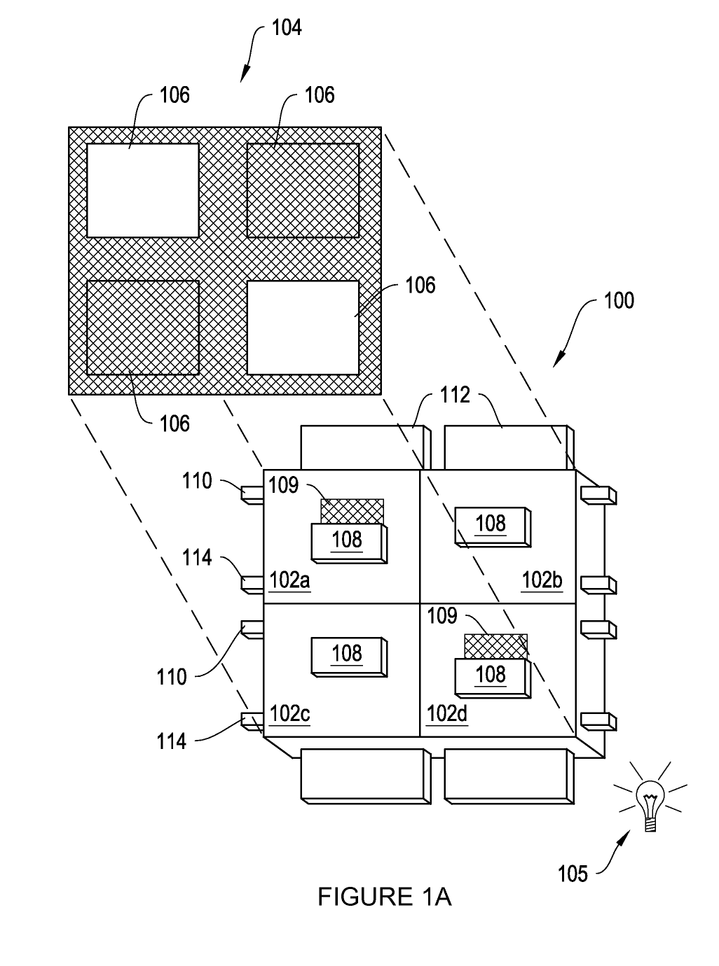

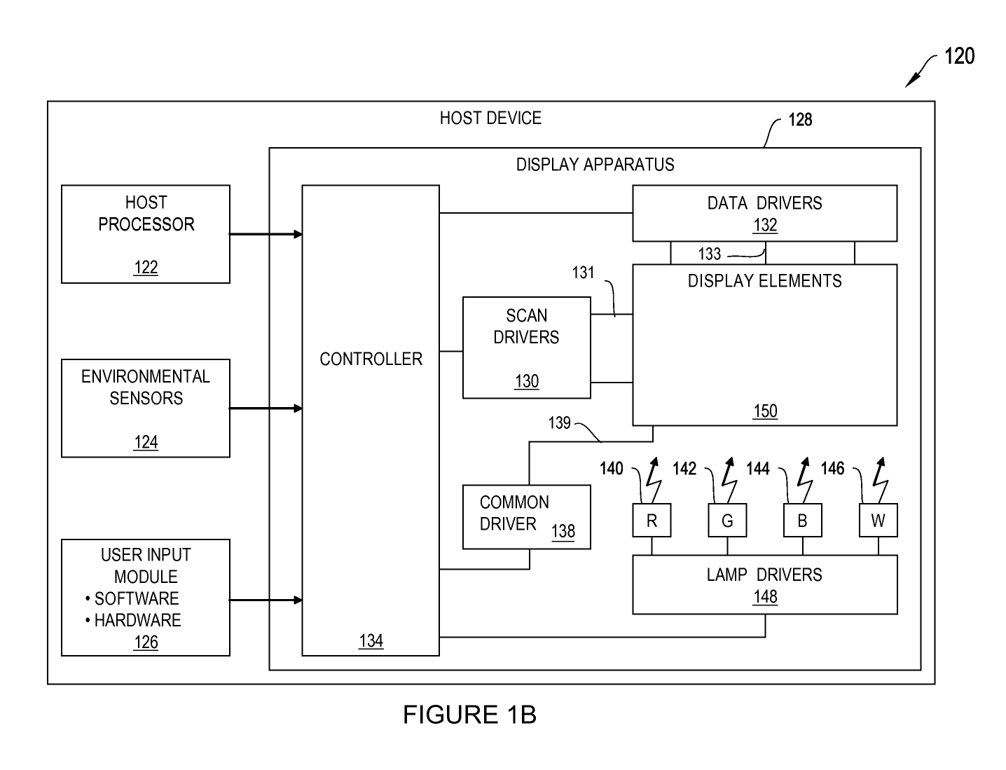

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

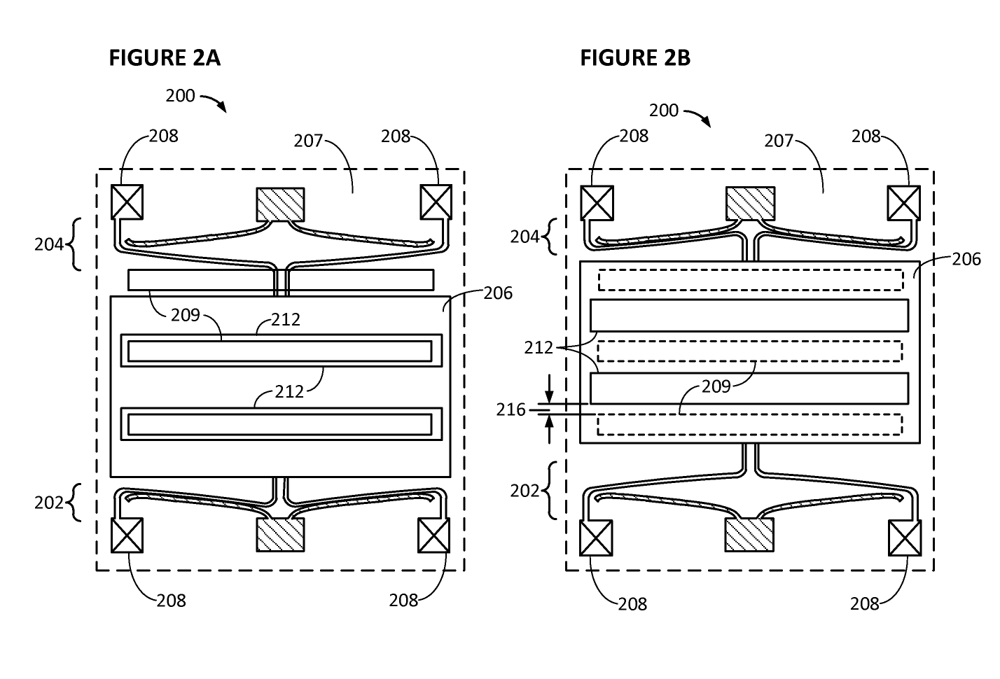

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

In some implementations, inherent stresses created during the deposition and etching of the materials used to form the shutter assembly 200 may cause the shutter to deform out of its desired configuration. Undesired deformation of the shutter, in turn, may result in undesirable operation of the shutter assembly. In some implementations, ribs can be introduced in the shutter to mitigate the deformation of the shutter.

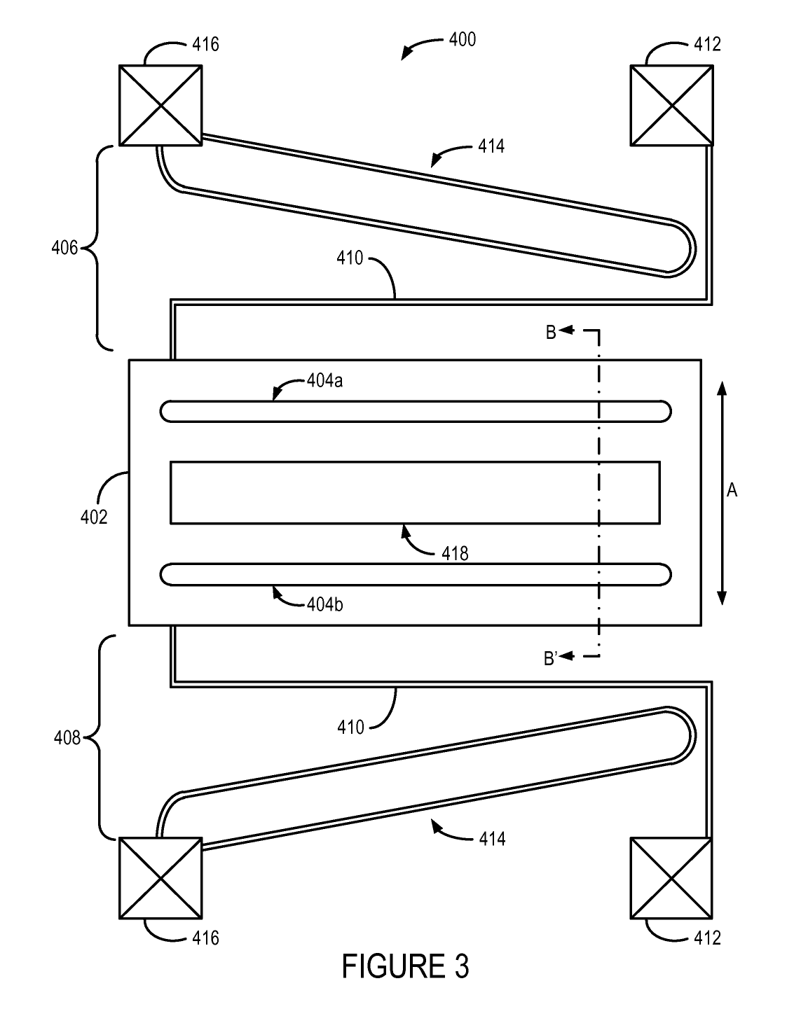

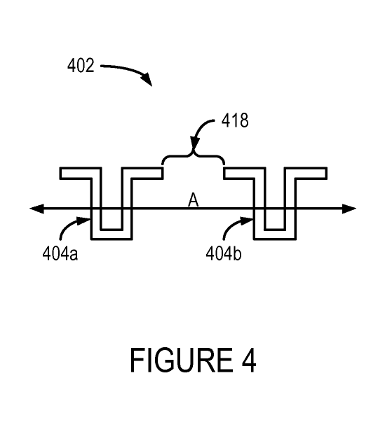

FIGS. 3 and 4 show two views of an example shutter assembly 400 including a shutter 402 having ribs. In particular, FIG. 3 shows a top view of the example shutter assembly 400, and FIG. 4 shows a cross-sectional view of the shutter 402, of the example shutter assembly 400 shown in FIG. 3 along dotted line B-B′ as depicted in FIG. 3.

As mentioned above, FIG. 3 shows a top view of the shutter assembly 400 including a shutter 402 having ribs. In particular, the shutter 402 shown in FIG. 3 includes a first rib 404a and a second rib 404b. The shutter assembly 400 includes a first actuator 406 and an opposing second actuator 408 on either side of the shutter 402. The first actuator 406 and the second actuator 408 can position the shutter 402 in OPEN and CLOSED states over one or more apertures (not shown) in a light blocking layer formed on a substrate on which the shutter assembly 400 is formed and/or formed on an opposing substrate. Each of the first and second actuators 406 and 408 can be implemented using compliant beam electrodes. For example, each of the first and the second actuators 406 and 408 can include a load beam electrode 410, with one end attached to the shutter 402, and the other end attached to a load anchor 412. Each of the first and the second actuators 406 and 408 also can include looped drive beams 414 attached to a drive anchor 416.

Each of the first and the second actuators 406 and 408 can be individually controlled by applying appropriate voltages to their respective compliant beams. One of the first and the second actuator 406 and 408 can be utilized as an open actuator that positions the shutter 402 in an OPEN state, while the other of the first and the second actuator 406 and 408 can be utilized as a close actuator that positions the shutter 402 in a CLOSED state. The first and the second actuators 406 and 408 can move the shutter 404 in a plane substantially parallel to the substrate over which the shutter assembly is formed. For example, the first and the second actuators 406 and 408 can move the shutter 402 in a direction indicated by the arrow labeled “A” in FIG. 3.

The shutter 402 can include an opening 418 that extends along a dimension of the shutter 402 that is perpendicular to the direction of motion of the shutter 402. In the OPEN state, the shutter 402 is positioned such that the opening 418 is substantially aligned with an aperture in the light blocking layer. In some implementations, in the OPEN state, another aperture may be uncovered beside the shutter 402.

As mentioned above, the shutter 402 includes first and second ribs 404a and 404b to improve the mechanical properties of the shutter 402 and mitigate shutter deformation. The first rib 404a and the second rib 404b can each extend along the length of the opening 418. In some implementations, the shutter 402 can include additional ribs. For example, in some implementations, the shutter 402 can include ribs along the breadth of the opening 418. In some implementations, the shutter 402 can include additional ribs parallel or perpendicular to one or both of the first and the second ribs 404a and 404b.

FIG. 4 shows a cross-sectional view of the shutter 402 of the shutter assembly 400 along a cross-sectional line B-B′ shown in FIG. 3. In particular, the cross-sectional view shows the first and second ribs 404a and 404b protruding out of the plane of the shutter 402 (for example, out of the plane of the page of FIG. 3) towards the substrate over which the shutter is formed. The cross-sectional view also shows the first and the second ribs 404a and 404b in relation to the direction of motion of the shutter 402 indicated by the arrow labeled “A”. Specifically, the first and the second ribs 404a and 404b are substantially normal to the direction of motion of the shutter 402.

In some implementations, the shutter assembly 400 is positioned within a cavity formed by the substrate over which the shutter assembly 400 is formed and another substrate opposing the substrate. The cavity can be filled with a fluid and subsequently sealed. In some implementations, the fluid may partially or completely surround the shutter assembly 400. In some implementations, the fluid can serve as a lubricant, an insulator, or a light refracting component within the display device. The fluid can include liquids or gases. In some implementations, a liquid having low viscosity, low coefficient of friction, high dielectric constant, and high refractive index, can be provided. Examples of fluid include, without limitations, de-ionized water, oil, methanol, ethanol and other alcohols, paraffins, olefins, ethers, silicone oils, ketones, fluorinated silicone oils, fluorinated ketones, fluorinated ethers, or other natural or synthetic solvents or lubricants.

While the fluid can provide several benefits mentioned above, in some implementations, the fluid may undesirably impact the—dynamic characteristics of the shutter 402 having the first and the second ribs 404a and 404b. As shown in FIG. 4, the first and the second ribs 404a and 404b are positioned such that they protrude out of the plane of the shutter 402. Thus, when the shutter 402, which is immersed in the fluid, moves in the direction indicated by the arrow labeled “A”, the movement of the shutter is impeded by the protruding first and second ribs 404a and 404b in the fluid. As a result, the fluid has a damping effect on the motion of the shutter 402. In some implementations, the damping effect of the fluid on the shutter 402 may reduce the speed of operation of the shutter 402. In some implementations, actuation voltages provided to the first and second actuators 406 and 408 may have to be increased to compensate for the reduction in the speed of operation of the shutter 402 due to the damping effect of the fluid. An increase in the actuation voltages, in turn, may result in an increase in the power consumption of the display device.

As discussed below in further detail, the ribs on the shutter 402 can be configured in a manner such that the damping in the motion of the shutter 402 caused by the ribs interacting with the fluid is reduced.

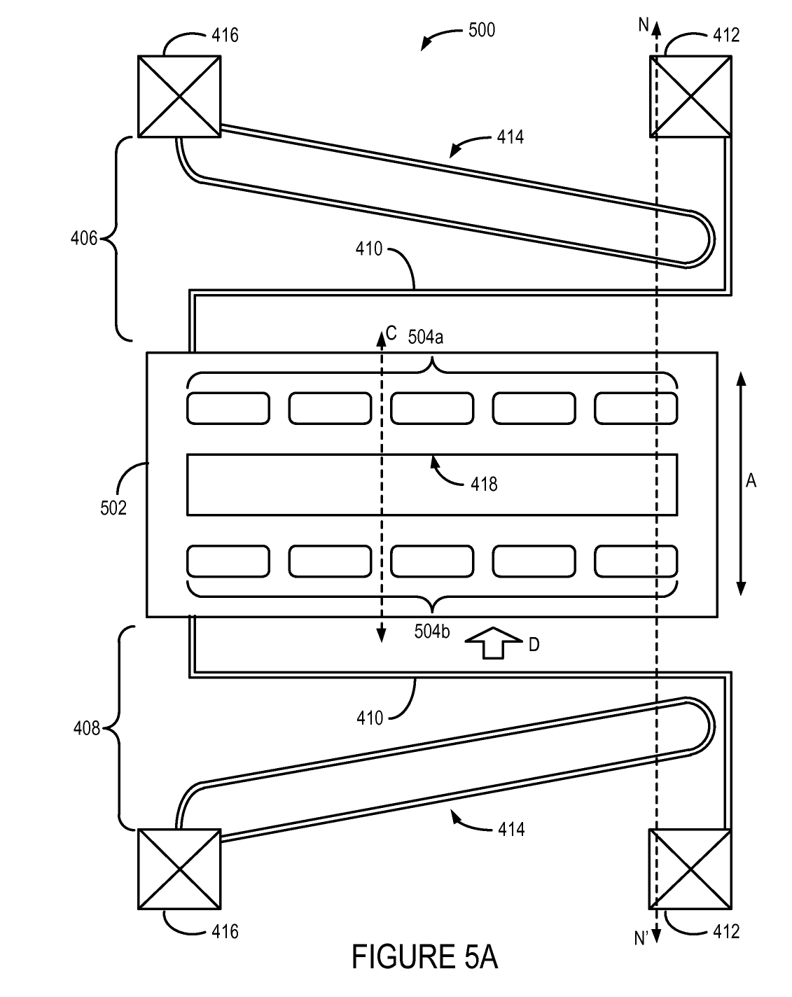

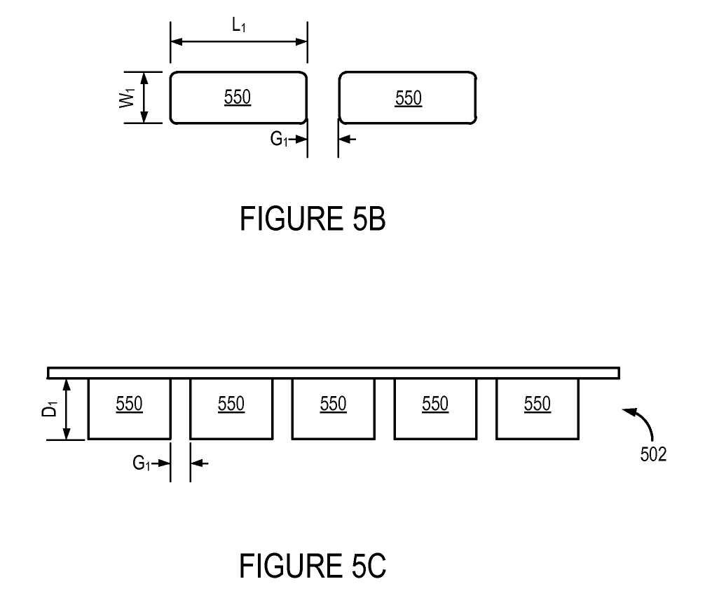

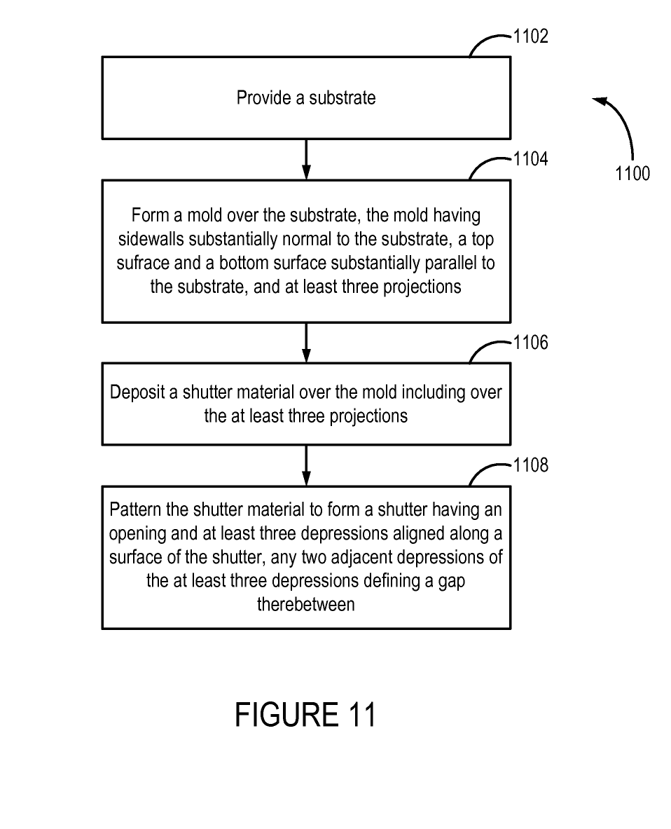

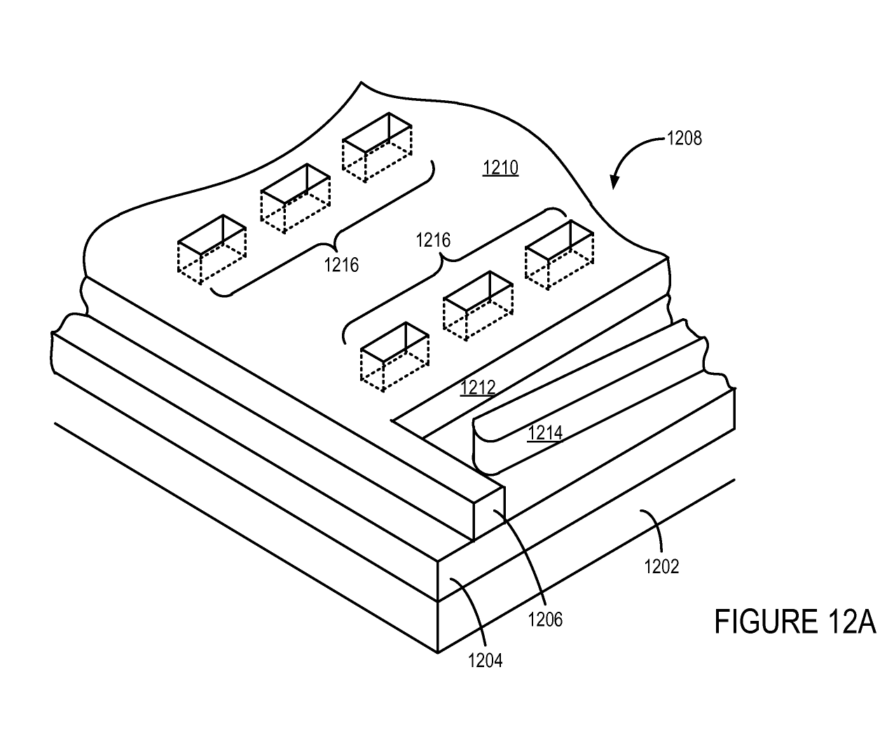

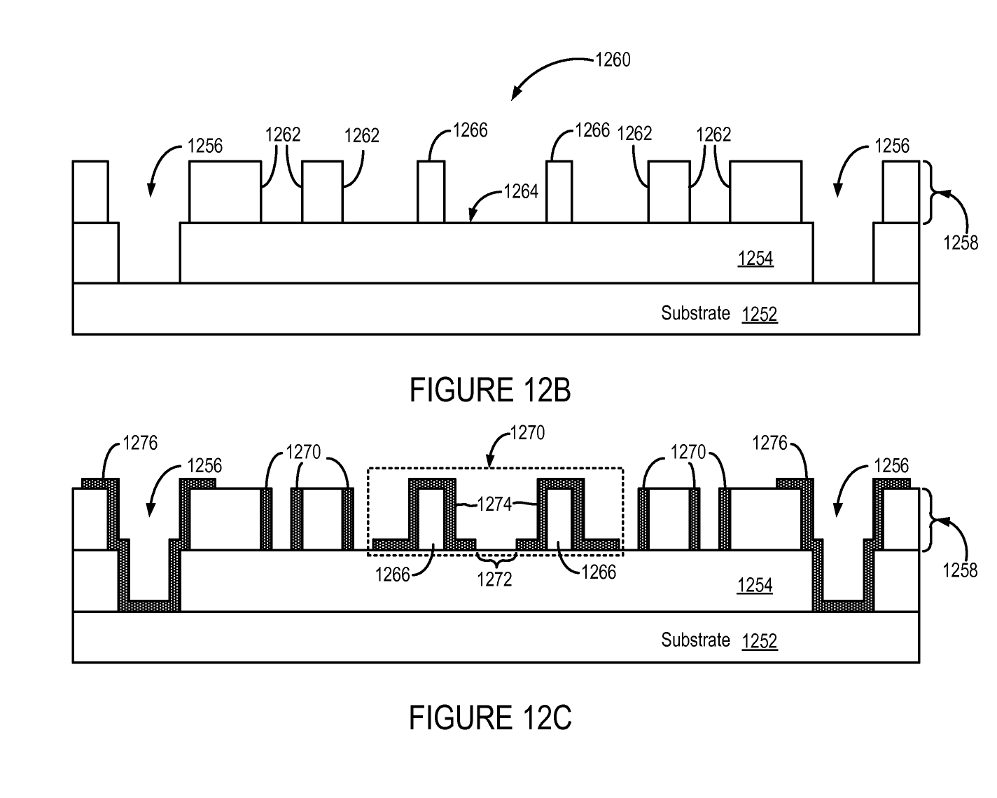

The following discussion discloses shutter assemblies having broken ribs. In particular, FIGS. 5A-10 show various views of various example implementations of shutter assemblies including shutters having broken ribs. FIG. 11 shows an example method for forming shutter assemblies including shutters having broken ribs. FIGS. 12A-12C show example stages of manufacturing a shutter assembly using the process shown in FIG. 11.

FIGS. 5A-5C show various views of an example shutter assembly 500 including a shutter 502 having broken ribs. Specifically, FIG. 5A shows a top view of the shutter assembly 500 including the shutter 502 having broken ribs. The shutter assembly 500 is similar to the shutter assembly 400 shown in FIG. 3. However, while the shutter 402 in FIG. 3 includes continuous ribs, the shutter 502 of the shutter assembly 500 shown in FIG. 5A includes broken ribs. The shutter assembly 500 functions in a manner similar to that described with respect to the shutter assembly 400 shown in FIG. 3. The shutter 502 includes two sets of broken ribs: a first set of broken ribs 504a and a second set of broken ribs 504b. The first set and the second set of broken ribs 504a and 504b are formed on either side of the opening 418 formed through the shutter 502. In some implementations, each of the first set and the second set of broken ribs 504a and 504b can include more than two broken ribs.

The first set and the second set of broken ribs 504a and 504b are formed along the length (or longitudinal dimension) of the opening 418. Both the first set of broken ribs 504a and the second set of broken ribs 504b include gaps between adjacent ribs. During the motion of the shutter 502 in the direction indicated by the arrow-A, the gaps between the ribs provide a path (indicated by an arrow labeled “C”) for the fluid to flow. By allowing the fluid to flow between the ribs, the damping effect of the fluid on the shutter 502 is reduced. As a result, for a given actuation voltage, the shutter 502 can operate at increased speed as compared to, for example, the shutter 402 (having continuous ribs 404a and 404b) shown in FIG. 3.

FIGS. 5B and 5C show additional views of the shutter 502. Specifically, FIG. 5B shows an expanded top-view of two adjacent ribs 550 from the first set of broken ribs 504a or the second set of broken ribs 504b, while FIG. 5C shows a side-view of the shutter 502 viewed in the direction indicated by an arrow labeled “D”. Referring to FIGS. 5B and 5C, each rib 550 has a length L₁ between about 0.5 micron and about 50 microns (such as between about 1 micron to about 40 microns), a width W₁ between about 0.5 microns and about 50 microns (such as between about 1 micron to about 25 microns), and a depth D₁ between about 0.1 microns and about 50 microns (such as between about 1 micron and about 25 microns). The ribs 550 are separated by a gap G₁ between about 0.5 microns and about 30 microns (such as between about 1 micron to about 20 microns), which provides a path for fluid flow between the ribs 550.

In some implementations, one or both of the first set of ribs 504a and 504b can include at least two ribs of unequal dimensions. In some implementations, one or both of the first set of ribs 504a and 504b can include at least two adjacent ribs that are separated by a gap that is unequal to the gap separating any other two adjacent ribs.

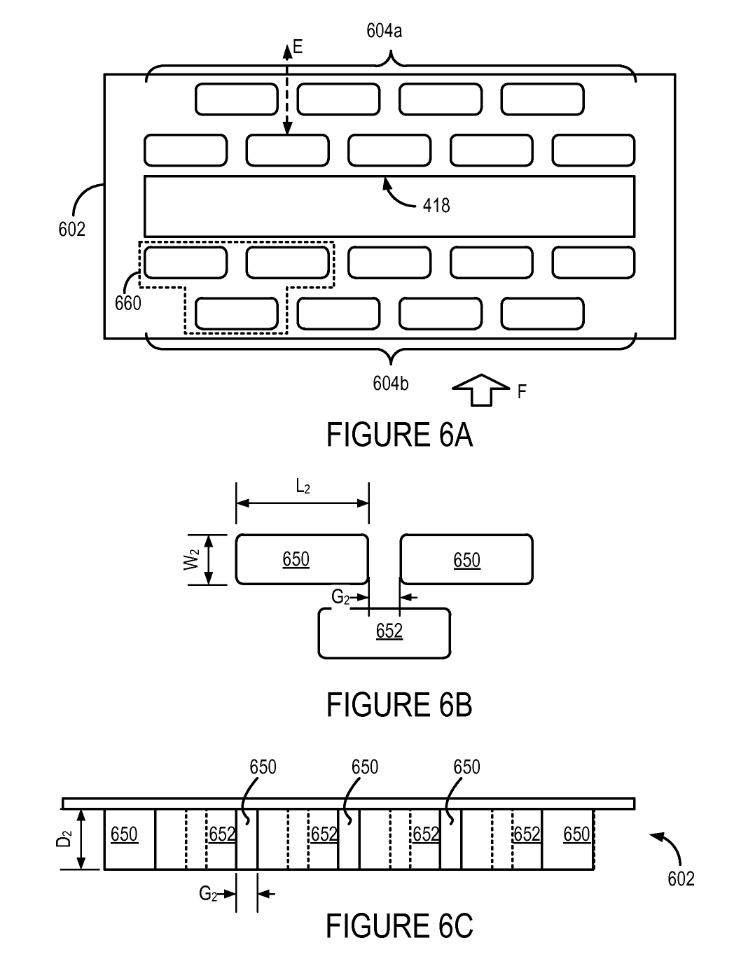

FIGS. 6A-6C show various views of an example shutter 602 having broken ribs. Specifically, FIG. 6A shows a top view of the example shutter 602 having a first set of staggered ribs 604a and a second set of staggered ribs 604b. The shutter 602 shown in FIG. 6A can be utilized in place of the shutter 402 in the shutter assembly 400 shown in FIG. 3 or in place of shutter 502 in the shutter assembly 500 shown in FIG. 5A.

Each of the first and the second set of staggered ribs 604a and 604b include two rows of broken ribs where the ribs in one row are offset in relation to the ribs in the other row. Each row includes more than two ribs. Further, two adjacent ribs in each row are spaced apart to form a gap. Due to the offset in the positions of the ribs in one row in relation to the ribs in the other row, a straight line path across the shutter 602 through the gaps is not provided by the first and the second set of staggered ribs 604a and 604b. For example, the arrow labeled “E” shows that the straight line passing through a gap between the ribs in the first row intersects with at least one rib in the second row. In some implementations, not providing a straight line path between the gaps across the shutter can reduce the risk of bending or deformation in the shutter along an axis parallel to the direction of motion of the shutter 602, thereby improving the resistance to deformation of the shutter 602.

FIG. 6B shows an expanded view of a plurality of ribs of the shutter 600 shown in FIG. 6A. In particular, FIG. 6B shows an expanded view of the ribs within a boundary 660 shown in FIG. 6A. FIG. 6B shows ribs 650 and 652 from a first row and the second row, respectively, of the second set of staggered ribs 604b. FIG. 6C shows a side-view of the shutter 602 shown in FIG. 6A viewed in the direction indicated by the arrow labeled “F” (i.e., the direction of motion of the shutter 602). As shown in FIG. 6B and 6C, each rib 650 and 652 has a length L₂ between about 0.5 micron and about 50 microns (such as between about 1 micron to about 40 microns), a width W₂ between about 0.5 microns and about 50 microns (such as between about 1 micron to about 25 microns), and a depth D₂ between about 0.1 microns and about 50 microns (such as between about 1 micron and about 40 microns). The two adjacent ribs 650 are separated by a gap G₂ between about 0.5 microns and about 50 microns (such as between about 1 micron to about 20 microns). When viewed in the direction of motion of the shutter 602, the gaps formed between the ribs 652 in one row of the second set of the staggered ribs 604b are blocked by the ribs 650 in the other row of the second set of the staggered ribs 604b. Similarly, gaps formed between ribs 650 in one row of the second set of staggered ribs 604b are blocked by the ribs 652 in the other row of the second set of staggered ribs 604b. Thus all lines along the direction of motion of the shutter 602, except near the edges of the shutter 602, pass through at least one of staggered ribs 650 or 652. Viewed in another way, any line that is coplanar with the shutter 602, directed along the direction of motion of the shutter 602 and intersecting the opening 418, passes through at least one of the staggered ribs 650 or 652.

As mentioned above, not providing a straight line path between the gaps across the shutter can reduce the risk of bending or deformation in the shutter along such a line, thereby improving the mechanical stability of the shutter 602. In some implementations, the ribs 650 and 652 are sized and spaced such that no straight line, other than those substantially normal to the direction of motion of the shutter, can pass through the shutter (other than at its edges) without intersecting a rib 650 or 652), eliminating additional potential bending axes. In some implementations, the ribs 650 and 652 are sized and spaced such that any straight line that is coplanar with the shutter and passing through a gap between the ribs 650 intersects the rib 652. Viewed in another way, any straight line that is coplanar with the shutter and passing through a gap between the ribs 652 intersects a rib 650.

In some implementations, one or both of the first set of staggered set of ribs 604a and the second set of staggered ribs 604b can include more than two rows of ribs. In some implementations, ribs in each row of the first and the second set of staggered ribs 604a and 604b can be offset in position with respect to the ribs in the adjacent row. In some implementations, dimensions of at least two ribs in a row of ribs may be unequal. In some implementations, dimensions of ribs in one row can be different from the dimensions of the ribs in the other rows.

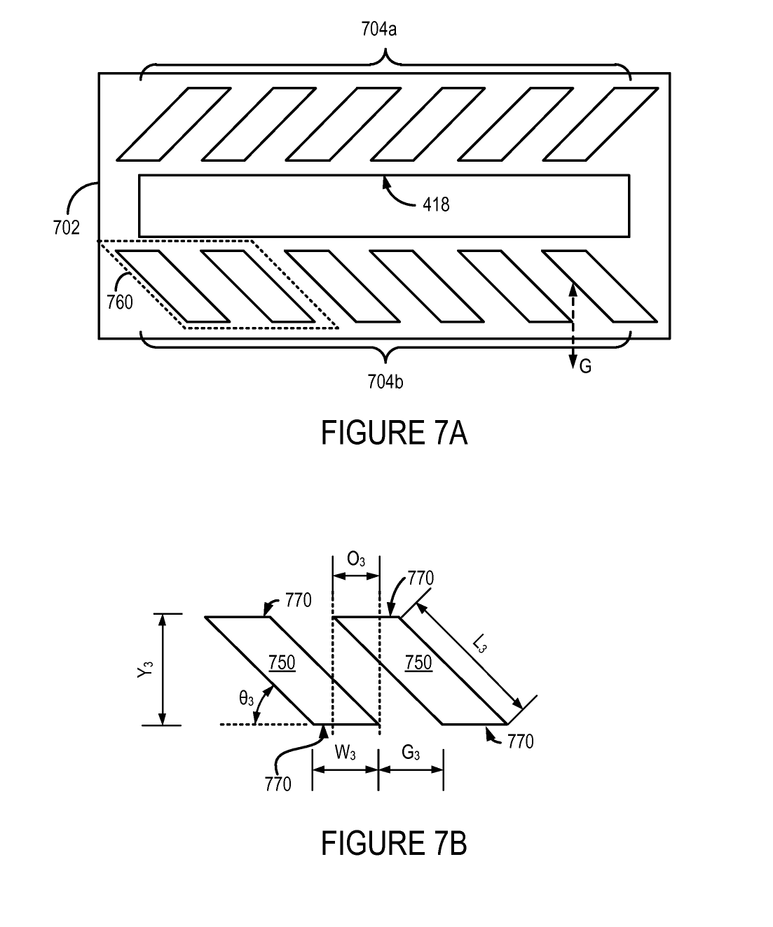

FIGS. 7A and 7B show various views of an example shutter 702 having angled ribs. Specifically, FIG. 7A shows a top-view of an example shutter 702 having angled ribs. The shutter 702 includes a first set of angled ribs 704a and a second set of angled ribs 704b. The shutter 702 can be utilized in place of the shutter 402 in the shutter assembly 400 shown in FIG. 3 or in place of the shutter 502 in the shutter assembly 500 shown in FIG. 5A. The first set and the second set of angled ribs 704a and 704b are formed on either side of the opening 418. Each of the first and the second set of angled ribs 704a and 704b include ribs that form an angle with respect to the longer edge of the opening 418. In some implementations, the angle formed by the angled ribs in the first set of angled ribs 704a can be a mirror image of the angle formed by the angled ribs in the second set of angled ribs 704b about an axis that is parallel to the length of the opening 418. In some implementations, the angled ribs are separated by a gap. In some implementations, each of the first set and the second set of angled ribs 704a and 704b can include more than two angled ribs.

FIG. 7B shows an expanded top-view of two adjacent angled ribs 750 within a boundary 760 shown in FIG. 7A. The angled ribs 750 include leading edges 770 that are substantially normal to the direction of motion of the shutter 702. The angled ribs 750 form an angle θ₃ with the edge of the opening 418. The adjacent angled ribs 750 include a length L₃ between about 0.5 micron and about 50 microns (such as between about 2 microns to about 25 microns), a width W₃ between about 0.5 micron and about 50 microns (such as between about 2 microns to about 25 microns), a projected length Y₃ along a dimension parallel to the direction of motion of the shutter 702 between about 0.5 micron and about 50 microns (such as between about 2 microns to about 25 microns), and define a gap G₃ between about 0.5 micron and about 30 microns (such as between about 2 microns to about 20 microns). The adjacent angled ribs 750 are positioned such that portions of the ribs 750 overlap by a distance θ₃ in a direction perpendicular to the direction of motion of the shutter 702 between about 0.5 micron and about 20 microns (such as between about 2 microns to about 10 microns). The adjacent angled ribs 750 are positioned such that any line (such as line labeled “G”) parallel to the direction of motion of the shutter 702 and passing though the gap between the angled ribs 750 intersects at least one edge of at least one of the two adjacent angled ribs 750.

In some implementations, one or both of the first set and the second set of angled ribs 704a and 704b can include more than one row of angled ribs. In some implementations, the dimensions of at least one angled rib within the first set or the second set of angled ribs 704a and 704b can be different than the dimensions of another angled rib.

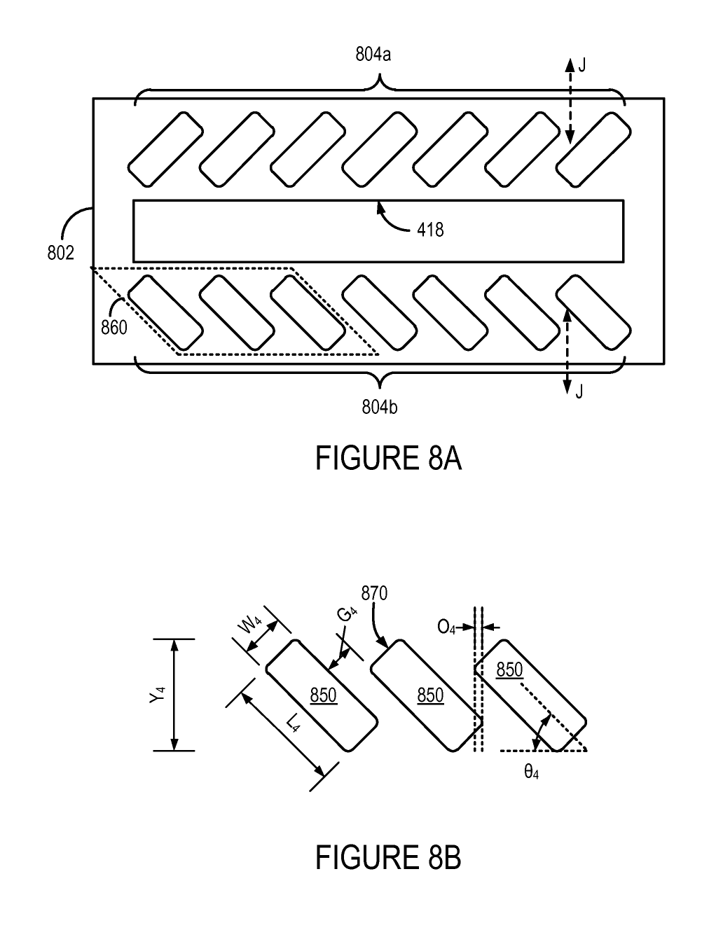

FIGS. 8A and 8B show various views of an example shutter 802 having angled ribs. In particular, FIG. 8A shows a top-view of the example shutter 802 having angled ribs. The shutter 802 includes ribs that are angled or tilted with respect to an edge of the shutter 802. Further, the leading edges of the ribs are not normal to the direction of motion of the shutter 802. The shutter 802 shown in FIG. 8A can be utilized in place of the shutter 402 in the shutter assembly 400 shown in FIG. 3 or in place of the shutter 502 in the shutter assembly 500 shown in FIG. 5A.

The shutter 802 includes a first set of angled ribs 804a and a second set of angled ribs 804b. The first and the second set of angled ribs 804a and 804b are formed on either side of the opening 418. In some implementations, the angle formed by the angled ribs in the first set of angled ribs 804a is a mirror image of the angle formed by the angled ribs in the second set of angled ribs 804b about an axis that is parallel to the length of the opening 418. In some implementations, the first set of angled ribs 804a have angles that are parallel to the second set of angled ribs 804b. In some implementations, each of the first set and the second set of angled ribs 804a and 804b can include more than two angled ribs.

FIG. 8B shows an expanded top-view of two adjacent angled ribs 850 within a boundary 860 shown in FIG. 8A. The angled ribs 850 include a leading edge 870 that also forms an angle with the leading edge of the shutter 802. The angular leading edge 870 is in contrast with the leading edge 770 of the angled ribs 750 shown in FIG. 7B which is parallel to the leading edge of the shutter 702. The angled ribs 850 have a width W₄ and a length L₄. Adjacent angled ribs 850 define a gap G₄ between about 0.5 micron and about 30 microns (such as between about 2 microns to about 20 microns), between their adjacent edges. The adjacent angled ribs 850 are positioned such that they overlap by a distance O₄ between about 0.5 microns and about 20 microns (such as between about 2 microns to about 10 microns). In some implementations, the overlap between adjacent angled ribs 850 does not allow a straight line path through the gap between the angled ribs 850. For example, the arrow labeled “J”, which is substantially parallel to the direction of motion of the shutter 802, intersects at least one edge of either of the two adjacent angled ribs. As mentioned above, not providing a straight line path through the gaps and across the shutter can improve the mechanical stability of the shutter 802. In some implementations, the adjacent angled ribs 850 can be positioned to not overlap, and provide a straight line path through the gaps.

In some implementations, the angled ribs 850 include a projected height Y₄ along a dimension parallel to the direction of motion of the shutter 702. The projected height Y₄ can be a function of the largest distance (Y_{rib}) between the edge of the shutter 802 and the edge of the opening 418 that can be used for forming the angled ribs 830. In some implementations, Y₄=Y_{rib}−2 microns (Y₄ can be between about 3 to about 14 microns). In some implementations, the width W₄ of the angled ribs 850 can have a range of about 3 microns to about a value determined by the expression: Y₄/sin(θ₄). In some implementations, the gap G₄ can have values between about 3 microns and about a value that is twice the width W₄ of the angled ribs 850. In some implementations, the length L₄ of the angled rib can be determined using the expression: Y₄/sin(90°−θ₄)−(W₄·sin θ₄). In some implementations, the angle θ₄ can have a range of values between about 0 degrees and about 60 degrees. In some implementations, the angle θ₄ can have a value of about 45 degrees.

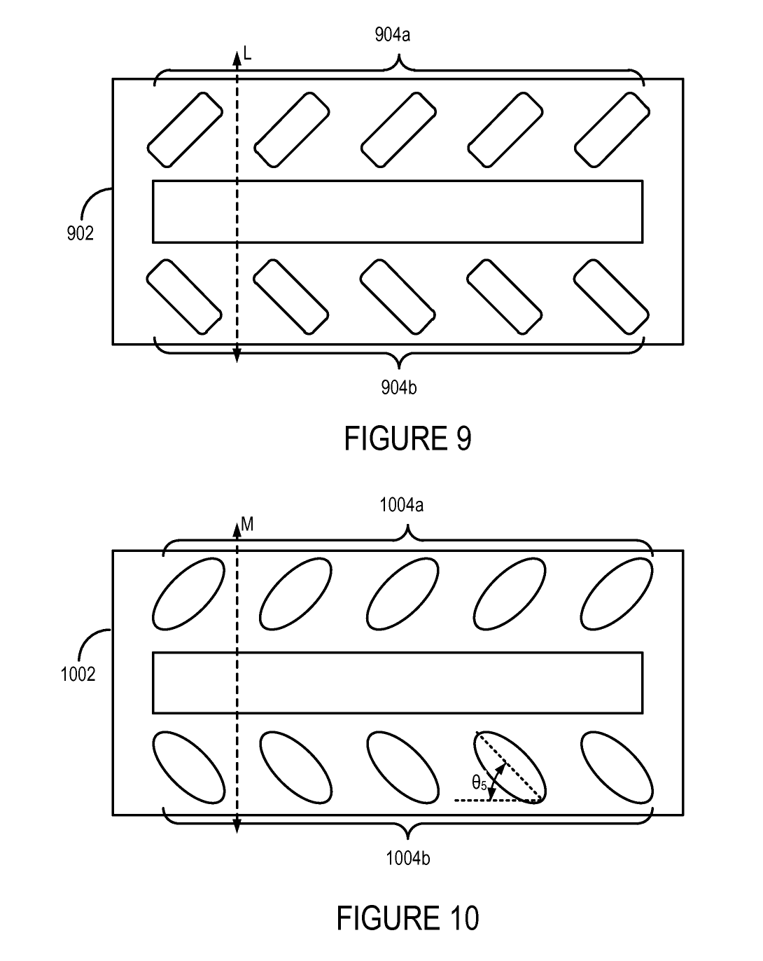

FIG. 9 shows a top view of an example shutter 902 having non-overlapping ribs. The shutter 902 can be utilized in place of the shutter 402 in the shutter assembly 400 shown in FIG. 3 or in place of the shutter 502 in the shutter assembly 500 shown in FIG. 5A. FIG. 9 shows the shutter 902 including a first set of angled ribs 904a and a second set of angled ribs 904b. The first set and the second set of angled ribs 904a and 904b include angled ribs similar to those in the first and the second set of angled ribs 804a and 804b shown in FIG. 8A. However, the ribs in the first and the second set of angled ribs 904a and 904b do not overlap. This results in a straight line path through the gap between adjacent ribs, as shown by arrow labeled “L”. This straight line path results in further reduction in fluid damping on the shutter 902 in comparison to the shutters 502, 602, 702 and 802 shown in FIGS. 5A, 6A, 7A, and 8A. In some implementations, each of the first set and the second set of angled ribs 904a and 904b can include more than two angled ribs.

FIG. 10 shows a top view of an example shutter 1002 having elliptical-shaped ribs. The shutter 1002 can be utilized in place of the shutter 402 in the shutter assembly 400 shown in FIG. 3 or in place of the shutter 502 in the shutter assembly 500 shown in FIG. 5A. FIG. 10 shows the shutter 1004a including a first set of angled elliptical ribs and a second set of angled elliptical ribs 1004b. The first set and the second set of elliptical ribs can include elliptical-shaped ribs, as compared to substantially rectangular shaped ribs 850 shown in FIG. 8A. The long axis of the elliptical-shaped ribs can form an angle θ₅ with the leading edge of the shutter 1002. In some implementations, θ₅ can range from about 0° to about 60°, such as about 45°. The elliptical-shaped ribs can be formed to include gaps between adjacent elliptical-shaped ribs. In some implementations, the elliptical-shaped ribs can be positioned such that a straight line path exists through the gap between adjacent elliptical-shaped ribs. For example, arrow labeled “M” indicates a straight line path between two adjacent elliptical-shaped ribs. In some implementations, the elliptical shaped ribs are spaced closer together to provide for some degree of overlap, eliminating any such straight line path. In some implementations, ribs with other shapes, for example, circles, triangles, etc., also can be utilized.

FIG. 11 shows a flow diagram of an example process 1100 for forming a shutter assembly. In particular, the process 1100 can be utilized for forming the shutter assemblies including shutters shown in FIGS. 5A-10 having a plurality of ribs.

FIGS. 12A-12C show example stages of manufacturing a shutter assembly. In particular, FIG. 12A and 12B show results of a patterning of molds to facilitate the formation of ribs in a shutter, while FIG. 12C shows the result of patterning a shutter material deposited on the mold shown in FIG. 12B. The manufacturing stage results shown in FIGS. 12A-12C are discussed further below in relation to the process 1100.

The process 1100 includes providing a substrate (stage 1102), forming a mold over the substrate, the mold having sidewalls substantially normal to the substrate, a top surface and a bottom surface substantially parallel to the substrate, and at least three projections (stage 1104), depositing a shutter material over the mold including the at least three projections (stage 1106), and patterning the shutter material to form a shutter having an opening and at least three depressions aligned along a surface of the shutter, any two adjacent depressions of the at least three depressions defining a gap therebetween (stage 1108).

The process 1100 includes providing a substrate (stage 1102). One example of the result of this process stage is shown in FIGS. 12A and 12B. For example, FIG. 12A and 12B show substrates 1202 and 1252, respectively, each provided for forming respective shutter assemblies. In some implementations, the substrates 1202 and 1252 can be transparent substrates, for example, made of glass or plastic.

The process 1100 also includes forming a mold over the substrate, the mold having sidewalls substantially normal to the substrate, a top surface and a bottom surface substantially parallel to the substrate, and at least three projections (stage 1104). One example of the result of this process stage is shown in FIG. 12A. Specifically, FIG. 12A shows a mold 1208 formed over a substrate 1202. The mold includes a first sacrificial layer 1204 and a second sacrificial layer 1206 that has been deposited and patterned over the first sacrificial layer 1204. The mold includes a top surface 1210 and sidewalls 1212 and 1214. The top surface 1210 is substantially parallel to the substrate 1202, while the sidewalls 1212 and 1214 are substantially normal to the substrate 1202. The sidewalls 1212 and 1214 can be used to form compliant beam electrodes for actuators. For example, the sidewall 1212 can be used to form the load beam 410 shown in FIG. 5A. Similarly, the sidewall 1214 can be used to form a compliant looped drive beam such as the drive beam 414 shown in FIG. 5A.

As discussed below, the top surface 1210 can be used to form a shutter having an opening and ribs. To facilitate the formation of the ribs, the second sacrificial layer 1206 can be patterned to form projections in the mold 1208. Specifically, the projections can extend out of the plane of the top surface 1210 of the mold 1208 and extend towards the substrate 1202. For example, as shown in FIG. 12A, these projections take the form of cavities 1216 in the mold 1208. In some implementations, the second sacrificial layer 1206 can be etched or photopatterned to form the cavities 1216. The cavities 1216 shown in FIG. 12A are substantially rectangular, and can be utilized to form, for example, the first set of ribs 504a and the second set of ribs 504b shown in FIG. 5A. However, the cavities 1216 can be appropriately sized and shaped based on the desired size and shape of the ribs incorporated into the shutter. For example, the cavities 1216 can be formed at an angle such that when the ribs are formed in the cavities 1216, the ribs are aligned at an angle with a long edge of an opening formed in the shutter. Generally, the cavities 1216 can be shaped and sized to form any of the ribs discussed above in relation to FIGS. 5A-10.

Materials for use as the first and second sacrificial materials 1204 and 1206 can include polyimide. Other candidate sacrificial layer materials include, without limitation, polymer materials such as fluoropolymer, benzocyclobutene, polyphenylquinoxylene, parylene, or polynorbornene. These materials are chosen for their ability to planarize rough surfaces, maintain mechanical integrity at processing temperatures in excess of 250° C., and their ease of etch and/or thermal decomposition during removal. In other implementations, the sacrificial layers 1204 and/or 1206 are formed from a photoresist, such as polyvinyl acetate, polyvinyl ethylene, and phenolic or novolac resins. An alternate sacrificial layer material used in some implementations is silicon dioxide (SiO₂), which can be removed preferentially as long as other electronic or structural layers are resistant to the hydrofluoric acid solutions used for its removal. One such suitable resistant material is silicon nitride. Another alternate sacrificial layer material is silicon (Si), which can be removed preferentially as long as electronic or structural layers are resistant to the fluorine plasmas or xenon difluoride (XeF₂) used for its removal, such as most metals and silicon nitride. Yet another alternate sacrificial layer material is aluminum (Al), which can be removed preferentially as long as other electronic or structural layers are resistant to strong base solutions, such as concentrated sodium hydroxide (NaOH) solutions. Suitable materials include, for example, chromium (Cr), nickel (Ni), molybdenum (Mo), tantalum (Ta) and Si. Still another alternate sacrificial layer material is copper (Cu), which can be removed preferentially as long as other electronic or structural layers are resistant to nitric or sulfuric acid solutions. Such materials include, for example, Cr, Ni, and Si.

Another example of the result of the process stage 1104 is shown in FIG. 12B. FIG. 12B shows a cross-section of a stage of formation of a shutter assembly. For example, the cross-section shown in FIG. 12B can represent the cross-section of the formation of the shutter assembly 500 shown in FIG. 5A along the cross-section line N-N′. FIG. 12B shows a mold 1260 formed over a substrate 1252. The mold 1260 includes a first sacrificial layer 1254 that is deposited and patterned over the substrate 1252 and includes anchor openings 1256 to facilitate the formation of anchors. A second sacrificial layer 1258 is deposited and patterned over the first sacrificial layer 1254. The second sacrificial layer 1258 is patterned to maintain the anchor openings 1256. The mold 1260 further includes sidewalls 1262 to facilitate the formation of compliant drive and load beams. The mold 1260 also includes a bottom surface 1264 (which, in some implementations can be the top surface of the first sacrificial layer 1254 exposed after the etching of the second sacrificial layer 1258) over which a shutter having ribs can be formed.

To facilitate the formation of ribs, the second sacrificial layer 1258 can be patterned to form projections in the mold 1260. Specifically the projections can extend out of the plane of the bottom surface 1264 of the mold 1260 and away from the substrate 1252. For example, as shown in FIG. 12B, these projections take the form of posts 1266 in the mold 1260. In some implementations, the posts 1266 can be substantially rectangular, and can be utilized to form, for example, the first set of ribs 504a and the second set of ribs 504b shown in FIG. 5A. However, the posts 1266 can be appropriately sized based on the desired size and shape of the ribs. The materials and the method of formation and patterning of the first and the second sacrificial layers 1254 and 1258 can be similar to those used in the formation and patterning of the first and second sacrificial layers 1204 and 1206 of the mold 1208 discussed above in relation to FIG. 12A.

The process further includes depositing a shutter material over the mold including the at least three projections (stage 1106). The deposition of the shutter material can include deposition of one or more mechanical layers, conductive layers, and dielectric layers. At least one of the mechanical layers can be deposited to thicknesses in excess of 0.15 microns, as one or both of the mechanical layers serves as the principal load bearing and mechanical actuation member for the shutter assembly, though in some implementations, the mechanical layers may be thinner. Candidate materials for the mechanical layers include, without limitation, metals such as Al, Cu, Ni, Cr, Mo, titanium (Ti), Ta, niobium (Nb), neodymium (Nd), or alloys thereof; dielectric materials such as aluminum oxide (Al₂O₃), SiO₂, tantalum pentoxide (Ta₂O₅), or silicon nitride; or semiconducting materials such as diamond-like carbon, Si, germanium (Ge), gallium arsenide (GaAs), cadmium telluride (CdTe) or alloys thereof At least one of the layers, such as the conductor layer, should be electrically conducting so as to carry charge on to and off of the actuation elements. Candidate materials include, without limitation, Al, Cu, Ni, Cr, Mo, Ti, Ta, Nb, Nd, or alloys thereof or semiconducting materials such as diamond-like carbon, Si, Ge, GaAs, CdTe or alloys thereof In some implementations employing semiconductor layers, the semiconductors are doped with impurities such as phosphorus (P), arsenic (As), boron (B), or Al.

In some implementations, the order of the layers in the shutter assembly can be inverted, such that one or more outer layers of the shutter assembly is formed from a conductor layer while one or more inner layers of the shutter assembly is formed from a mechanical layer. In some implementations, the shutter assembly includes one conductor layer and one mechanical layer. The shutter material is deposited to a thickness of less than about 2 microns. In some implementations, the shutter material is deposited to have a thickness of less than about 1.5 microns. In some other implementations, the shutter material is deposited to have a thickness of less than about 1.0 microns, and as thin as about 0.10 microns.

The shutter material can be deposited over the mold 1208 shown in FIG. 12A, such that the shutter material is deposited over all the exposed surfaces of the mold 1208. Similarly, the shutter material can be deposited over the mold 1260 shown in FIG. 12B such that the shutter material is deposited over all exposed surfaces of the mold 1260. In some implementations, the shutter material can be deposited using deposition techniques such as, without limitation, chemical vapor deposition, sputtering, and evaporation.

The process 1100 also includes patterning the shutter material to form a shutter having an opening and at least three depressions aligned along a surface of the shutter, any two adjacent depressions of the at least three depressions defining a gap therebetween (stage 1108). One example of this process stage is shown in FIG. 12C. For example 12C shows the result of the deposition and patterning of a shutter material over the mold 1260 shown in FIG. 12B. The shutter material is patterned to form a shutter 1270. The shutter 1270 includes an opening 1272 and ribs or depressions 1274 on either side of the opening 1272. The ribs 1274 are formed over the posts 1266 of the mold 1260 shown in FIG. 12B. For example, the shutter 1270 can be similar to the shutter 502 shown in FIG. 5A, where the opening 1272 can represent the opening 418 and the ribs 1274 can represent the first set of ribs 504a and the second set of ribs 504b on either side of the opening 418. FIG. 12C also shows the formation of anchors 1276 within the anchor openings 1256 and compliant beams 1278 formed over the sidewalls of the mold 1260 shown in FIG. 12B. In a similar manner, a shutter with ribs can be formed by deposition and patterning of shutter material over the mold 1208 shown in FIG. 12A.

In some implementations, the shutter material deposited over the mold 1260 (or the mold 1208 shown in FIG. 12A) can be patterned by first depositing and patterning an etch mask, and etching the shutter material to form the shutter assembly including the shutter having at least three ribs, by anisotropically etching the shutter material. In some implementations, the anisotropic etching of the shutter material may be followed by an isotropic etching step.

In some implementations, the patterning of the shutter material can be followed by a release step in which the mold, including the first and the second sacrificial layers (such as the first and second sacrificial layers 1254 and 1258 shown in FIG. 12C), is removed. The removal of the mold releases all moving parts from the substrate except at the anchor points, such as the anchors 1276 shown in FIG. 12C. In some implementations, polyimide sacrificial materials are removed in an oxygen plasma. Other polymer materials used for the sacrificial layer also can be removed in an oxygen plasma, or in some cases by thermal pyrolysis. Some sacrificial layer materials (such as SiO₂) can be removed by wet chemical etching or by vapor phase etching.

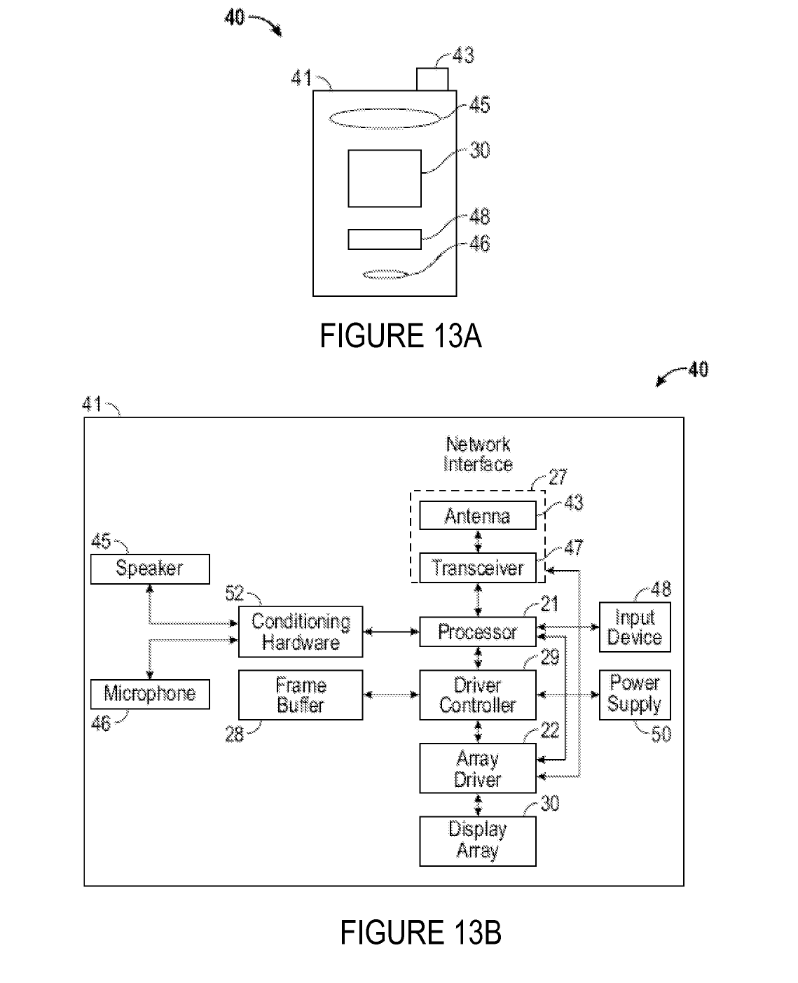

FIGS. 13A and 13B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming In addition, the housing 41 may be made from any of a variety of materials, including, but not limited to: plastic, metal, glass, rubber and ceramic, or a combination thereof The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus, comprising:
a substrate;
an anchor disposed on the substrate; and
a planar body supported over the substrate by the anchor, wherein the planar body includes:
at least three depressions extending out of the plane of the planar body; wherein any two adjacent depressions of the at least three depressions define a gap therebetween, and wherein the at least three depressions are aligned along a surface of the planar body.

2. The apparatus of claim 1, wherein the at least three depressions extend out of the plane of the planar body and protrude towards the substrate.

3. The apparatus of claim 1, wherein the at least three depressions are aligned in at least two rows, each row including more than two of the at least three depressions, along the surface of the planar body.

4. The apparatus of claim 3, wherein gaps defined by any two adjacent depressions in one of the at least two rows align with a depression in another of the at least two rows in a direction of motion of the planar body.

5. The apparatus of claim 3, wherein the at least three depressions are aligned in at least two rows along the surface of the planar body such that any line, coplanar with the planar body, along a direction of motion of the planar body and intersecting an opening in the planar body passes through at least one of the at least three depressions.

6. The apparatus of claim 3, wherein the at least three depressions are aligned in at least two rows along the surface of the planar body such that any line, coplanar with the planar body, passing through a gap defined by any two of the at least three depressions in one row intersects another of the at least three depressions in another row.

7. The apparatus of claim 1, wherein the at least three depressions include a leading edge that forms an angle with respect to a direction of motion of the planar body.

8. The apparatus of claim 7, wherein any line, coplanar with the planar body, along a direction of motion of the planar body and intersecting an opening in the planar body passes thorough at least one of the at least three depressions.

9. The apparatus of claim 1, wherein the lengths of the at least three depressions are less than or equal to about 25 microns.

10. The apparatus of claim 1, wherein the at least three depressions are elliptical shaped.

11. The apparatus of claim 1, further comprising:
a display;
a processor that is capable of communicating with the display, the processor being capable of processing image data; and
a memory device capable of communicating with the processor.

12. The apparatus of claim 11, further comprising:
a driver circuit capable of sending at least one signal to the display; and
a controller capable of sending at least a portion of the image data to the driver circuit.

13. The apparatus of claim 11, further comprising:
an image source module capable of sending the image data to the processor, wherein the image source module includes at least one of a receiver, transceiver, and transmitter.

14. The apparatus of claim 11, further comprising:
an input device capable of receiving input data and communicating the input data to the processor.

15. A method of forming a display apparatus, comprising:
providing a substrate;
forming a mold over the substrate, the mold having sidewalls substantially normal to the substrate, a top surface and a bottom surface substantially parallel to the substrate, and at least three projections;
depositing a shutter material over the mold including over the at least three projections; and
patterning the shutter material to form a shutter having an opening and at least three depressions aligned along a surface of the shutter, any two adjacent depressions of the at least three depressions defining a gap therebetween.

16. The method of claim 15, wherein forming the mold over the substrate having at least three projections in the mold includes forming cavities within the top surface of the mold extending towards the substrate.

17. The method of claim 15, wherein forming the mold over the substrate having at least three projections in the mold includes forming posts in the mold extending away from the bottom surface of the mold.

18. The method of claim 15, wherein patterning the shutter material includes patterning the shutter material to form the at least three depressions aligned in at least two rows, each row including more than two of the at least three depressions, along the surface of the shutter.

19. The method of claim 18, wherein patterning the shutter material to form the at least three depressions aligned in at least two rows along the surface of the shutter includes patterning the shutter material such that gaps defined by any two adjacent depressions in one of the at least two rows align with a depression in another of the at least two rows in a direction of motion of the shutter.

20. The method of claim 18, wherein patterning the shutter material to form the at least three depressions aligned in at least two rows along the surface of the shutter includes patterning the shutter material such that any line, coplanar with the shutter, along a direction of motion of the shutter and intersecting the opening, passes through at least one of the at least three depressions.

21. The apparatus of claim 18, wherein patterning the shutter material to form the at least three depressions aligned in at least two rows along the surface of the shutter includes patterning the shutter material such that any line, coplanar with the planar body, passing through a gap defined by any two of the at least three depressions in one row intersects another of the at least three depressions in another row.

22. The method of claim 15, wherein patterning the shutter material to form a shutter having an opening and at least three depressions aligned along a surface of the shutter, any two adjacent depressions of the at least three depressions defining a gap therebetween, includes patterning the shutter material such that the at least three depressions include a leading edge forming an angle with respect to a direction of motion of the shutter.

23. The method of claim 15, wherein patterning the shutter material to form a shutter having an opening and at least three depressions aligned along a surface of the shutter, any two adjacent depressions of the at least three depressions defining a gap therebetween includes patterning the shutter material such that the lengths of the at least three depressions is less than or equal to about 25 microns.

24. The method of claim 15, wherein forming the mold over the substrate having at least three projections in the mold includes forming elliptical shaped at least three projections in the mold.
